(19) United States
(12) Patent Application Publication
(10) Pub. No.: US 2024/0014405 A1
(43) Pub. Date: Jan. 11, 2024

(54) Current Collector Sheet For Lead-Acid Storage Battery, Lead-Acid Storage Battery, And Bipolar Lead-Acid Storage Battery

(71) Applicants: The Furukawa Battery Co., Ltd., Yokohama (JP); Furukawa Electric Co., Ltd., Tokyo (JP)

(72) Inventors: Ayano Koide, Iwaki (JP); Keizo Yamada, Iwaki (JP); Atsushi Sato, Iwaki (JP); Hiroshi Kaneko, Tokyo (JP); Yoshiaki Ogiwara, Tokyo (JP)

(21) Appl. No.: 18/472,489

(22) Filed: Sep. 22, 2023

Related U.S. Application Data
(63) Continuation of application No. PCT/JP2022/011329, filed on Mar. 14, 2022.

(30) Foreign Application Priority Data
Mar. 26, 2021 (JP) 2021-053771

(51) Int. Cl. H01M 4/68; H01M 10/18; H01M 50/593

(52) U.S. Cl. CPC H01M 4/685; H01M 10/18; H01M 50/593

(57) ABSTRACT

A current collector sheet suitable as a positive electrode current collector plate used by being attached to a resin substrate surface of a space forming member constituting a bipolar lead-acid storage battery is provided. A current collector sheet for a lead-acid storage battery has a Vickers hardness of 10 or less when measured by a micro Vickers hardness test specified in JIS Z2244:2009, has a thickness of less than 0.5 mm, and is formed of a lead alloy in which a content ratio of tin (Sn) is 1.0 mass % or more and less than 2.0 mass %, a content ratio of calcium (Ca) is 0.005 mass % or more and less than 0.030 mass %, and a balance is lead (Pb) and unavoidable impurities.

### CROSS-REFERENCE TO RELATED APPLICATION(S)

This application is a continuation of PCT Application No. PCT/JP2022/011329, filed Mar. 14, 2022, the disclosure of which is incorporated herein in its entirety by reference.

### TECHNICAL FIELD

The present invention relates to a current collector sheet for a lead-acid storage battery, a lead-acid storage battery, and a bipolar lead-acid storage battery.

### BACKGROUND

In recent years, the number of power generation facilities using natural energy such as sunlight and wind power has increased. In such power generation facilities, because the power generation amount cannot be controlled, the power load is leveled by using a storage battery. That is, when the amount of power generation is larger than a consumption, a difference is charged into the storage battery, and when the amount of power generation is smaller than a consumption, a difference is discharged from the storage battery. As the storage battery described above, a lead-acid storage battery is frequently used from the viewpoint of economic efficiency, safety, and the like. As such a conventional lead-acid storage battery, for example, a bipolar lead-acid storage battery described in JP Patent Publication No. 6124894 B2 is known.

The bipolar lead-acid storage battery has a frame shape and has a resin substrate attached to the inside of a resin frame. Lead layers are arranged on both surfaces of the substrate. A positive active material layer is adjacent to the lead layer formed on one surface of the substrate, and a negative active material layer is adjacent to the lead layer formed on the other surface of the substrate. In addition, a resin spacer having a frame shape is provided, and a glass mat impregnated with an electrolytic solution is provided inside the spacer. A plurality of frames and spacers are alternately stacked, and the frames and the spacers are bonded to each other with an adhesive or the like. In addition, the lead layers formed on both surfaces of the substrate are connected via a through-hole provided in the substrate.

That is, the bipolar lead-acid storage battery described in JP Patent Publication No. 6124894 B2 includes a plurality of cell members each including a positive electrode including a positive electrode current collector plate and a positive active material layer, a negative electrode including a negative electrode current collector plate and a negative active material layer, and a separator (e.g., a glass mat) interposed between the positive electrode and the negative electrode, the plurality of cell members being arranged in a stack manner with intervals, and a plurality of space forming members each forming a plurality of spaces for individually housing the plurality of cell members. In addition, the space forming member includes a substrate that covers at least one of a side of the positive electrode and a side of the negative electrode of the cell member, and a frame body (i.e., a frame portion and a spacer of a bipolar plate and an end plate) that surrounds a side surface of the cell member. In addition, the cell member and the substrate of the space forming member are alternately arranged in a stack state, the cell members are electrically connected in series, and adjacent frame bodies are joined to each other.

JP Patent Publication No. 6124894 B2 describes the use of a lead foil as a lead layer arranged on both surfaces of a substrate but does not describe what kind of composition is specifically used as the lead foil.

Regarding a composition of a lead alloy for a current collector plate of a general lead-acid storage battery, for example, JP Patent Publication No. 5399272 B2 describes the following. Because early lead-calcium alloys usually have a relatively high content ratio (for example, 0.08% or more) of calcium and a relatively low content ratio (for example, 0.35 to 0.5%) of tin, positive electrode grids produced from these alloys have an advantage of being rapidly hardened and easily handled and pasted onto plates, but Pb₃Ca precipitates formed on top of Sn₃Ca precipitates tend to harden the alloy and tend to lead to increased corrosion and growth of the positive electrode grids in high temperature applications. In addition, a lead alloy generally used as an alloy for a grid and having a significantly low content ratio of calcium (0.02 to 0.05%) is significantly soft, is difficult to handle, and is significantly slowly hardened. Lead alloys having a significantly low calcium content ratio usually contain a relatively low amount of tin and a relatively high amount of silver, and these alloys tend to have high corrosion resistance, but these alloys are difficult to handle and require a special treatment for making a thin current collector plate (i.e., a current collector sheet).

### SUMMARY

One of the causes of deterioration of the lead-acid storage battery is corrosion of the positive electrode current collector plate. As the battery use period becomes longer, corrosion of the positive electrode current collector plate progresses. When corrosion progresses, the positive active material cannot be held, and the performance as a battery is deteriorated. In addition, in a case where a positive electrode material (e.g., a positive electrode current collector plate or a positive active material) dropped due to corrosion comes into contact with the negative electrode, a short circuit may occur.

In the case of the bipolar lead-acid storage battery, it is required to make the positive electrode current collector plate used by being attached to the resin substrate surface of the space forming member as thin as possible. In this case, there is a problem that the performance deterioration and short circuit described above due to corrosion are likely to appear.

An object of the present invention is to provide a current collector sheet suitable as a positive electrode current collector plate used by being attached to a resin substrate surface of a space forming member constituting a bipolar lead-acid storage battery.

As a result of intensive studies, the present inventors have found that when a thin current collector sheet formed of lead or a lead alloy is attached to a resin substrate surface with an adhesive, a surface of the current collector sheet does not follow the substrate surface, and air bubbles remain between the substrate surface and the current collector plate. Further, the present inventors have found that the residual air bubbles can be reduced by reducing the hardness of the current collector sheet.

In order to solve the problems described above, one aspect of the present invention is a current collector sheet for a lead-acid storage battery that is formed of lead or a lead alloy, has a Vickers hardness of 10 or less when measured by a micro Vickers hardness test specified in JIS Z2244:2009, and has a thickness of less than 0.5 mm. Therefore, it is possible to realize preferred stickiness, which is an object of the present invention.

In addition, as the current collector sheet for a lead-acid storage battery, a positive electrode current collector plate formed of a lead alloy in which a content ratio of tin (Sn) is 1.0 mass % or more and less than 2.0 mass %, a content ratio of calcium (Ca) is 0.005 mass % or more and less than 0.030 mass %, and a balance is lead (Pb) and unavoidable impurities is used, such that it is possible to further suppress corrosion of the positive electrode.

According to the current collector sheet for a lead-acid storage battery of the present invention, it can be expected that the current collector sheet will be suitable as a positive electrode current collector plate that is used by being attached to a resin substrate surface of a space forming member constituting a bipolar lead-acid storage battery.

### BRIEF DESCRIPTION OF THE DRAWINGS

FIG. 1 is a cross-sectional view illustrating a schematic configuration of a bipolar lead-acid storage battery according to an embodiment of the present invention.

FIG. 2 is a partially enlarged view of the bipolar lead-acid storage battery of FIG. 1.

### DETAILED DESCRIPTION

Hereinafter, embodiments of the present invention will be described, but the present invention is not limited to the following embodiments. In the embodiments described below, technically preferable limitations are made to implement the present invention, but no limitation is an essential requirement of the present invention.

Overall Configuration

First, an overall configuration of a bipolar lead-acid storage battery of the embodiment will be described.

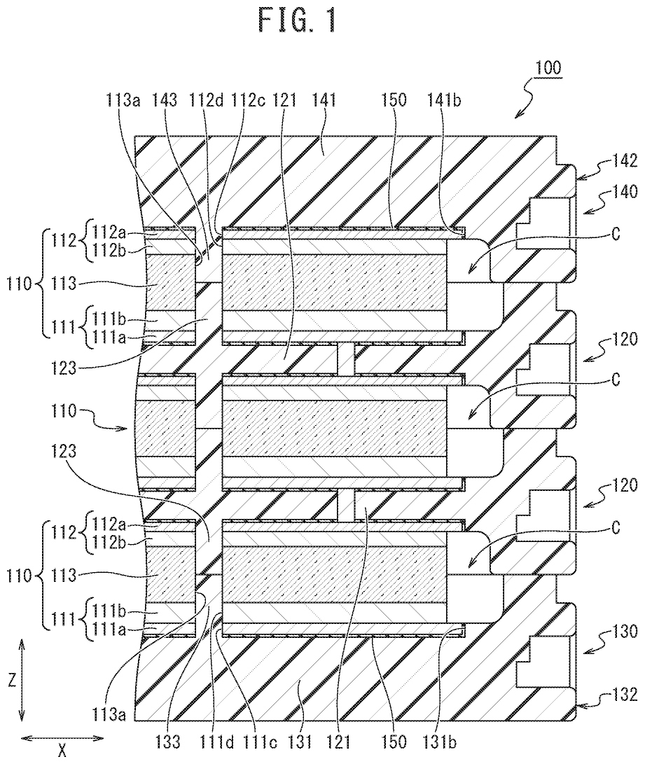

As illustrated in FIG. 1, a bipolar lead-acid storage battery 100 of the embodiment includes a plurality of cell members 110, a plurality of biplates 120 (as space forming members), a first end plate 130 (as a space forming member), and a second end plate 140 (as a space forming member). FIG. 1 illustrates the bipolar lead-acid storage battery 100 in which three cell members 110 are stacked, but the number of cell members 110 is determined by battery design. In addition, the number of the biplates 120 is determined according to the number of the cell members 110.

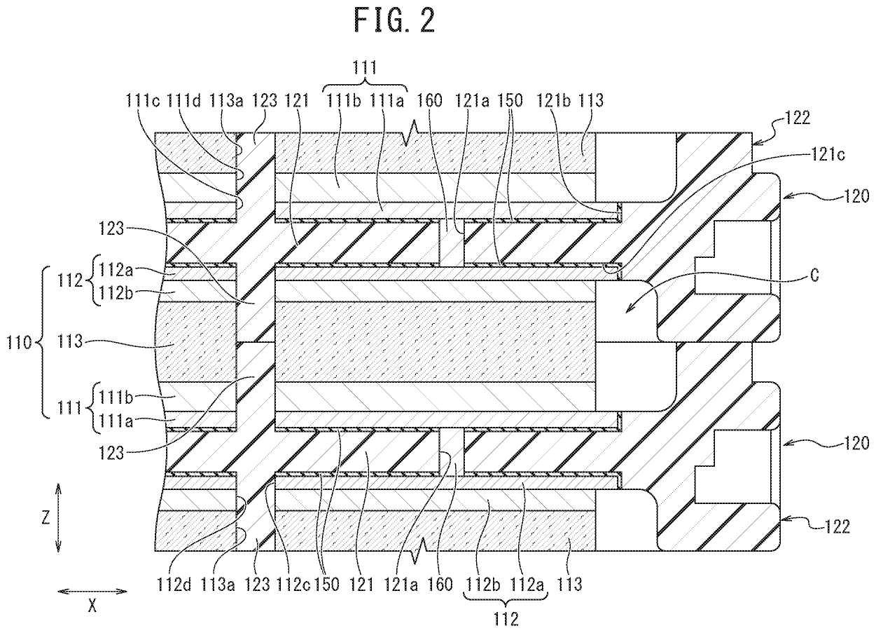

A stacking direction of the cell members 110 is defined as a Z direction (vertical direction in FIGS. 1 and 2), and a direction perpendicular to the Z direction is defined as an X direction.

The cell member 110 includes a positive electrode 111, a negative electrode 112, and a separator 113 (also called an electrolyte layer). The separator 113 is impregnated with an electrolytic solution. The positive electrode 111 includes a positive electrode lead foil 111a (i.e., a positive electrode current collector plate) and a positive active material layer 111b. The negative electrode 112 includes a negative electrode lead foil 112a (i.e., a negative electrode current collector plate) and a negative active material layer 112b. The separator 113 is interposed between the positive electrode 111 and the negative electrode 112. In the cell member 110, the positive electrode lead foil 111a, the positive active material layer 111b, the separator 113, the negative active material layer 112b, and the negative electrode lead foil 112a are stacked in this order.

A dimension (e.g., a thickness) in the Z direction is larger (thicker) in the positive electrode lead foil 111a than in the negative electrode lead foil 112a, and the dimension is larger (thicker) in the positive active material layer 111b than in the negative active material layer 112b.

The plurality of cell members 110 are arranged in a stack manner with intervals in the Z direction, and a substrate 121 of the biplate 120 is arranged at the interval. That is, the plurality of cell members 110 are stacked with the substrate 121 of the biplate 120 interposed therebetween.

The plurality of biplates 120, the first end plate 130, and the second end plate 140 are members for forming a plurality of spaces C (also called cells) for individually housing the plurality of cell members 110.

As illustrated in FIG. 2, the biplate 120 includes a substrate 121 having a rectangular planar shape, a frame body 122 covering four end surfaces of the substrate 121, and column portions 123 vertically protruding from both surfaces of the substrate 121. The substrate 121, the frame body 122, and the column portions 123 are integrally formed of a synthetic resin. Note that the number of column portions 123 protruding from each surface of the substrate 121 may be one or plural.

In the Z direction, a dimension of the frame body 122 is larger than a dimension (e.g., a thickness) of the substrate 121, and a dimension between protruding end surfaces of the column portions 123 is the same as the dimension of the frame body 122. A space C is formed between the substrate 121 and the substrate 121 by stacking the plurality of biplates 120 in contact with the frame body 122 and the column portions 123. A dimension of the space C in the Z direction is maintained by the column portions 123 that are in contact with each other.

Through-holes 111c, 111d, 112c, 112d, and 113a penetrating the column portion 123 are formed in the positive electrode lead foil 111a, the positive active material layer 111b, the negative electrode lead foil 112a, the negative active material layer 112b, and the separator 113, respectively.

A substrate 121 of the biplate 120 has a plurality of through-holes 121a penetrating the plate surface. A first recess 121b is formed on one surface of the substrate 121, and a second recess 121c is formed on the other surface of the substrate 121. A depth of the first recess 121b is deeper than that of the second recess 121c. Dimensions of the first recess 121b and the second recess 121c in the X direction and the Y direction correspond to the dimensions of the positive electrode lead foil 111a and the negative electrode lead foil 112a in the X direction and the Y direction.

The substrate 121 of the biplate 120 is arranged between the cell members 110 adjacent to each other in the Z direction. The positive electrode lead foil 111a of the cell member 110 is arranged in the first recess 121b of the substrate 121 of the biplate 120 with an adhesive layer 150 interposed therebetween.

In addition, the negative electrode lead foil 112a of the cell member 110 is arranged in the second recess 121c of the substrate 121 of the biplate 120 with the adhesive layer 150 interposed therebetween.

An electrical conductor 160 is arranged in the through-hole 121a of the substrate 121 of the biplate 120, and both end surfaces of the electrical conductor 160 are in contact with and coupled to the positive electrode lead foil 111a and the negative electrode lead foil 112a. That is, the positive electrode lead foil 111a and the negative electrode lead foil 112a are electrically connected by the electrical conductor 160. As a result, all of the plurality of cell members 110 are electrically connected in series.

As illustrated in FIG. 1, the first end plate 130 includes a substrate 131 that covers a side of the positive electrode of the cell member 110, a frame body 132 that surrounds the side surface of the cell member 110, and a column portion 133 that vertically protrudes from one surface of the substrate 131 (i.e., a surface of the biplate 120 arranged closest to the side of the positive electrode, the surface facing the substrate 121). A planar shape of the substrate 131 is rectangular, four end surfaces of the substrate 131 are covered with the frame body 132, and the substrate 131, the frame body 132, and the column portion 133 are integrally formed of a synthetic resin. Note that the number of column portions 133 protruding from one surface of the substrate 131 may be one or more but corresponds to the column portion 123 of the biplate 120 to be brought into contact with the column portion 133.

In the Z direction, a dimension of the frame body 132 is larger than a dimension (e.g., a thickness) of the substrate 131, and a dimension between protruding end surfaces of the column portion 133 is the same as the dimension of the frame body 132. A space C is formed between the substrate 121 of the biplate 120 and the substrate 131 of the first end plate 130 by stacking the frame body 132 and the column portion 133 in contact with the frame body 122 and the column portion 123 of the biplate 120 arranged on the outermost side (i.e., the positive electrode side). A dimension of the space C in the Z direction is maintained by the column portion 123 of the biplate 120 and the column portion 133 of the first end plate 130, which are in contact with each other.

Through-holes 111c, 111d, and 113a penetrating the column portion 133 are formed in the positive electrode lead foil 111a, the positive active material layer 111b, and the separator 113 of the cell member 110 arranged on the outermost side (i.e., the positive electrode side), respectively.

A recess 131b is formed on one surface of the substrate 131 of the first end plate 130. A dimension of the recess 131b in the X direction corresponds to a dimension of the positive electrode lead foil 111a in the X direction.

The positive electrode lead foil 111a of the cell member 110 is arranged in the recess 131b of the substrate 131 of the first end plate 130 with the adhesive layer 150 interposed therebetween.

In addition, the first end plate 130 includes a positive electrode terminal electrically connected to the positive electrode lead foil 111a in the recess 131b.

The second end plate 140 includes a substrate 141 that covers the negative electrode of the cell member 110, a frame body 142 that surrounds the side surface of the cell member 110, and a column portion 143 that vertically protrudes from one surface of the substrate 141 (i.e., a surface of the biplate 120 arranged closest to the negative electrode, the surface facing the substrate 121). A planar shape of the substrate 141 is rectangular, four end surfaces of the substrate 141 are covered with the frame body 142, and the substrate 141, the frame body 142, and the column portion 143 are integrally formed of a synthetic resin. Note that the number of column portions 143 protruding from one surface of the substrate 141 may be one or more but corresponds to the column portion 123 of the biplate 120 to be brought into contact with the column portion 143.

In the Z direction, a dimension of the frame body 142 is larger than a dimension (e.g., a thickness) of the substrate 131, and a dimension between two protruding end surfaces of the column portion 143 is the same as the dimension of the frame body 142. A space C is formed between the substrate 121 of the biplate 120 and the substrate 141 of the second end plate 140 by stacking the frame body 142 and the column portion 143 in contact with the frame body 122 and the column portion 123 of the biplate 120 arranged on the outermost side (i.e., the negative electrode side). A dimension of the space C in the Z direction is maintained by the column portion 123 of the biplate 120 and the column portion 143 of the second end plate 140, which are in contact with each other.

Through-holes 112c, 112d, and 113a penetrating the column portion 143 are formed in the negative electrode lead foil 112a, the negative active material layer 112b, and the separator 113 of the cell member 110 arranged on the outermost side (i.e., the negative electrode side), respectively.

A recess 141b is formed on one surface of the substrate 141 of the second end plate 140. A dimension of the recess 141b in the X direction and the Y direction corresponds to a dimension of the negative electrode lead foil 112a in the X direction and the Y direction.

The negative electrode lead foil 112a of the cell member 110 is arranged in the recess 141b of the substrate 141 of the second end plate 140 with the adhesive layer 150 interposed therebetween.

In addition, the second end plate 140 includes a negative electrode terminal electrically connected to the negative electrode lead foil 112a in the recess 141b.

Note that, as can be seen from the above description, the biplate 120 is a space forming member including the substrate 121 that covers both a side of the positive electrode and a side of the negative electrode of the cell member 110 and the frame body 122 that surrounds the side surface of the cell member 110. The first end plate 130 is a space forming member including the substrate 131 that covers the side of the positive electrode of the cell member 110 and the frame body 132 that surrounds the side surface of the cell member 110. The second end plate 140 is a space forming member including the substrate 141 that covers the negative electrode of the cell member 110 and the frame body 142 that surrounds the side surface of the cell member 110.

Configuration of Current Collector Plate

The positive electrode lead foil 111a (i.e., the positive electrode current collector plate) arranged in the recess 121b of the biplate 120 has a thickness of less than 0.5 mm (for example, 0.1 mm or more and 0.4 mm or less), is formed of a lead alloy in which a content ratio of tin (Sn) of 1.0 mass % or more and less than 2.0 mass %, a content ratio of calcium (Ca) of 0.005 mass % or more and less than 0.030 mass %, and a balance is lead (Pb) and unavoidable impurities, and has a Vickers hardness of 10 or less when measured by a micro Vickers hardness test specified in JIS Z2244:2009.

The positive electrode lead foil 111a (i.e., the positive electrode current collector plate) arranged in the recess 131b of the first end plate 130 has a thickness of, for example, 0.5 mm or more and 1.5 mm or less, is formed of a lead alloy in which a content ratio of tin (Sn) of 1.0 mass % or more and less than 2.0 mass %, a content ratio of calcium (Ca) of 0.005 mass % or more and less than 0.030 mass %, and a balance is lead (Pb) and unavoidable impurities, and has a Vickers hardness of 10 or less when measured by a micro Vickers hardness test specified in JIS Z2244:2009.

A thickness of the negative electrode lead foil 112a (i.e., the negative electrode current collector plate) arranged in the recess 121c of the biplate 120 is 0.05 mm or more and 0.3 mm or less. The alloy constituting the negative electrode lead foil 112a is, for example, a lead alloy in which a content ratio of tin (Sn) is 0.5 mass % or more and 2 mass % or less.

The negative electrode lead foil 112a (i.e., the negative electrode current collector plate) arranged in the recess 141b of the second end plate 140 has a thickness of, for example, 0.5 mm or more and 1.5 mm or less, and is formed of a lead alloy in which a content ratio of tin (Sn) is 0.5 mass % or more and 2 mass % or less.

Action and Effect

In the bipolar lead-acid storage battery 100 of the embodiment, the positive electrode lead foil 111a (i.e., the positive electrode current collector plate) has a thickness of less than 0.5 mm, a Vickers hardness of 10 or less when measured by a micro Vickers hardness test specified in JIS Z2244:2009. The positive electrode lead foil 111a is attached to a surface of each of the resin substrates 121, 131, and 141 of the space forming member with an adhesive.

Here, when air bubbles remain between the positive electrode lead foil 111a and the substrates 121, 131, and 141, the electrolytic solution of sulfuric acid is likely to enter therefrom, which may lead to a more fatal defect such as progress of corrosion from both the front and back surfaces of the positive electrode lead foil 111a or peeling of the current collector. Therefore, it is desirable to eliminate such bubbles more preferentially. Therefore, the Vickers hardness of the positive electrode lead foil 111a is set to 10 or less. As a result, when the positive electrode lead foil 111a is attached to the surface of each of the substrates 121, 131, and 141, the surface of the positive electrode lead foil 111a follows the substrate surface, and it is possible to attach the positive electrode lead foil while pushing out the air bubbles, such that it is possible to more easily prevent the air bubbles from being mixed in the attached surface. In addition, the work of attaching the positive electrode lead foil 111a to the surface of each of the resin substrates 121, 131, and 141 is also facilitated.

Furthermore, in a case of a bipolar lead-acid storage battery, because a current distribution is a reaction on the surface, there is no need to consider charge transfer resistance, and it is possible to thin the current collector plate. However, because a distance between the positive electrode and the negative electrode is short, there is a risk that a fatal defect occurs when the corrosion of the positive electrode current collector plate is large. The positive electrode lead foil 111a is formed of a lead alloy in which a content ratio of tin (Sn) is 1.0 mass % or more and less than 2.0 mass %, a content ratio of calcium (Ca) is 0.005 mass % or more and less than 0.030 mass %, and a balance is lead (Pb) and unavoidable impurities, such that corrosion of the positive electrode lead foil 111a can be further suppressed by a synergistic effect with the effect of reducing air bubbles.

### EXAMPLES

Lead alloy sheets Nos. 1 to 15 shown below were prepared.

A lead alloy sheet No. 1 was obtained by subjecting a rolled plate having a thickness of 0.4 mm and formed of a lead alloy in which a content ratio of calcium (Ca) was 0.000 mass %, a content ratio of tin (Sn) was 1.5 mass %, and a balance was lead (Pb) and unavoidable impurities to a heat treatment at 310° C. for 5 minutes in the air atmosphere. A Vickers hardness of the lead alloy sheet No. 1 was measured by a micro Vickers hardness test specified in JIS Z2244:2009, and the result was 7.

A lead alloy sheet No. 2 was obtained by subjecting a rolled plate having a thickness of 0.4 mm and formed of a lead alloy in which a content ratio of calcium (Ca) was 0.005 mass %, a content ratio of tin (Sn) was 1.5 mass %, and a balance was lead (Pb) and unavoidable impurities to a heat treatment at 200° C. for 30 minutes in the air atmosphere. A Vickers hardness of the lead alloy sheet No. 2 was measured by a micro Vickers hardness test specified in JIS Z2244:2009, and the result was 8.

A lead alloy sheet No. 3 was obtained by subjecting a rolled plate having a thickness of 0.3 mm and formed of a lead alloy in which a content ratio of calcium (Ca) was 0.010 mass %, a content ratio of tin (Sn) was 1.5 mass %, and a balance was lead (Pb) and unavoidable impurities to a heat treatment at 150° C. for 600 minutes in the air atmosphere. A Vickers hardness of the lead alloy sheet No. 3 was measured by a micro Vickers hardness test specified in JIS Z2244:2009, and the result was 7.

A lead alloy sheet No. 4 was obtained by subjecting a rolled plate having a thickness of 0.4 mm and formed of a lead alloy in which a content ratio of calcium (Ca) was 0.010 mass %, a content ratio of tin (Sn) was 1.5 mass %, and a balance was lead (Pb) and unavoidable impurities to a heat treatment at 200° C. for 60 minutes in the air atmosphere. A Vickers hardness of the lead alloy sheet No. 4 was measured by a micro Vickers hardness test specified in JIS Z2244:2009, and the result was 8.

A lead alloy sheet No. 5 was obtained by subjecting a rolled plate having a thickness of 0.4 mm and formed of a lead alloy in which a content ratio of calcium (Ca) was 0.010 mass %, a content ratio of tin (Sn) was 1.5 mass %, and a balance was lead (Pb) and unavoidable impurities to a heat treatment at 250° C. for 1 minute in the air atmosphere. A Vickers hardness of the lead alloy sheet No. 5 was measured by a micro Vickers hardness test specified in JIS Z2244:2009, and the result was 11.

A lead alloy sheet No. 6 was obtained by subjecting a rolled plate having a thickness of 0.4 mm and formed of a lead alloy in which a content ratio of calcium (Ca) was 0.010 mass %, a content ratio of tin (Sn) was 1.5 mass %, and a balance was lead (Pb) and unavoidable impurities to a heat treatment at 60° C. for 5 minutes in the air atmosphere. A Vickers hardness of the lead alloy sheet No. 6 was measured by a micro Vickers hardness test specified in JIS Z2244:2009, and the result was 13.

A lead alloy sheet No. 7 was obtained by subjecting a rolled plate having a thickness of 0.5 mm and formed of a lead alloy in which a content ratio of calcium (Ca) was 0.010 mass %, a content ratio of tin (Sn) was 1.5 mass %, and a balance was lead (Pb) and unavoidable impurities to a heat treatment at 310° C. for 5 minutes in the air atmosphere. A Vickers hardness of the lead alloy sheet No. 7 was measured by a micro Vickers hardness test specified in JIS Z2244:2009, and the result was 8.

A lead alloy sheet No. 8 was obtained by subjecting a rolled plate having a thickness of 0.4 mm and formed of a lead alloy in which a content ratio of calcium (Ca) was 0.010 mass %, a content ratio of tin (Sn) was 1.0 mass %, and a balance was lead (Pb) and unavoidable impurities to a heat treatment at 200° C. for 45 minutes in the air atmosphere. A Vickers hardness of the lead alloy sheet No. 8 was measured by a micro Vickers hardness test specified in JIS Z2244:2009, and the result was 8.

A lead alloy sheet No. 9 was obtained by subjecting a rolled plate having a thickness of 0.4 mm and formed of a lead alloy in which a content ratio of calcium (Ca) was 0.010 mass %, a content ratio of tin (Sn) was 2.0 mass %, and a balance was lead (Pb) and unavoidable impurities to a heat treatment at 250° C. for 10 minutes in the air atmosphere. A Vickers hardness of the lead alloy sheet No. 9 was measured by a micro Vickers hardness test specified in JIS Z2244:2009, and the result was 8.

A lead alloy sheet No. 10 was obtained by subjecting a rolled plate having a thickness of 0.4 mm and formed of a lead alloy in which a content ratio of calcium (Ca) was 0.010 mass %, a content ratio of tin (Sn) was 0.5 mass %, and a balance was lead (Pb) and unavoidable impurities to a heat treatment at 310° C. for 3 minutes in the air atmosphere. A Vickers hardness of the lead alloy sheet No. 10 was measured by a micro Vickers hardness test specified in JIS Z2244:2009, and the result was 8.

A lead alloy sheet No. 11 was obtained by subjecting a rolled plate having a thickness of 0.4 mm and formed of a lead alloy in which a content ratio of calcium (Ca) was 0.026 mass %, a content ratio of tin (Sn) was 1.5 mass %, and a balance was lead (Pb) and unavoidable impurities to a heat treatment at 100° C. for 300 minutes in the air atmosphere. A Vickers hardness of the lead alloy sheet No. 11 was measured by a micro Vickers hardness test specified in JIS Z2244:2009, and the result was 10.

A lead alloy sheet No. 12 was obtained by subjecting a rolled plate having a thickness of 0.4 mm and formed of a lead alloy in which a content ratio of calcium (Ca) was 0.030 mass %, a content ratio of tin (Sn) was 1.5 mass %, and a balance was lead (Pb) and unavoidable impurities to a heat treatment at 200° C. for 10 minutes in the air atmosphere. A Vickers hardness of the lead alloy sheet No. 12 was measured by a micro Vickers hardness test specified in JIS Z2244:2009, and the result was 11.

A lead alloy sheet No. 13 was obtained by subjecting a rolled plate having a thickness of 0.1 mm and formed of a lead alloy in which a content ratio of calcium (Ca) was 0.010 mass %, a content ratio of tin (Sn) was 1.5 mass %, and a balance was lead (Pb) and unavoidable impurities to a heat treatment at 120° C. for 900 minutes in the air atmosphere. A Vickers hardness of the lead alloy sheet No. 13 was measured by a micro Vickers hardness test specified in JIS Z2244:2009, and the result was 7.

A lead alloy sheet No. 14 was obtained by subjecting a rolled plate having a thickness of 0.4 mm and formed of a lead alloy in which a content ratio of calcium (Ca) was 0.010 mass %, a content ratio of tin (Sn) was 1.9 mass %, and a balance was lead (Pb) and unavoidable impurities to a heat treatment at 220° C. for 30 minutes in the air atmosphere. A Vickers hardness of the lead alloy sheet No. 14 was measured by a micro Vickers hardness test specified in JIS Z2244:2009, and the result was 8.

A lead alloy sheet No. 15 was obtained by subjecting a rolled plate having a thickness of 0.4 mm and formed of a lead alloy in which a content ratio of calcium (Ca) was 0.028 mass %, a content ratio of tin (Sn) was 1.5 mass %, and a balance was lead (Pb) and unavoidable impurities to a heat treatment at 150° C. for 60 minutes in the air atmosphere. A Vickers hardness of the lead alloy sheet No. 15 was measured by a micro Vickers hardness test specified in JIS Z2244:2009, and the result was 10.

A corrosion test was performed on each of the lead alloy sheets Nos. 1 to 15 by the following method.

Each lead alloy sheet was cut into a test piece having a width of 15 mm and a length of 70 mm, the test piece was placed in sulfuric acid having a specific gravity of 1.28 at 60° C. and subjected to continuous anodization at a constant potential of 1,350 mV (vs: Hg/Hg₂SO₄) for 28 days, and then a product oxide was removed. The mass was measured before and after the test, a mass loss by the test was calculated from the value, and a mass loss per total surface area of the test piece was taken as a corrosive amount. In addition, a cross-sectional structure after the corrosion test was observed with an electron microscope (magnification: 400 times) to examine whether or not the lead alloy sheet had through-holes.

In addition, a substrate formed of an ABS resin having a thickness of 2 mm was prepared, and each of the lead alloy sheets Nos. 1 to 12 was attached to one surface of the substrate to examine whether or not air bubbles intervened between the substrate and the sheet. The attachment method was as follows. First, a prescribed amount of epoxy resin was applied to one surface of the substrate. At that time, the substrate surface was held horizontally. Thereafter, a lead alloy sheet was placed on the surface of the substrate to which the epoxy resin was applied, and a rubber roller was brought into contact with an upper surface of the lead alloy sheet, and the sheet was moved from the end (right end) toward the end (left end), such that the lead alloy sheet was attached while the epoxy resin was extended.

Note that, because the substrate formed of an ABS resin and having a thickness of 2 mm has high transmittance, whether or not air bubbles intervene between the substrate and the sheet can be examined by visually observing the other surface of the substrate (i.e., the surface to which the lead alloy sheet is not attached).

These results are shown in Tables 1 to 4 together with the configuration of each lead alloy sheet.

TABLE 1

| | Configuration of lead alloy sheet | | | | | | | | |
|---|---|---|---|---|---|---|---|---|---|
| | Content | Content | | | | | | | |
| | ratio of | ratio of | | | | | Test results | | |
| | Ca in | Sn in | | Heat treatment | | | | | Bubble |
| | lead | lead | Plate | conditions | | | | Corrosive | intervention at |
| | alloy | alloy | thickness | Temperature | Time | Vickers | Through- | amount | the time of |
| No. | (mass %) | (mass %) | (mm) | (° C.) | (min) | hardness | hole | (mg/cm²) | attaching |
| 1 | 0.000 | 1.5 | 0.4 | 310 | 5 | 7 | Presence | 30 to 50 | Absence |
| 2 | 0.005 | 1.5 | 0.4 | 200 | 30 | 8 | Absence | 30 or less | Absence |
| 4 | 0.010 | 1.5 | 0.4 | 200 | 60 | 8 | Absence | 30 or less | Absence |
| 11 | 0.026 | 1.5 | 0.4 | 100 | 300 | 10 | Absence | 30 or less | Absence |
| 15 | 0.028 | 1.5 | 0.4 | 150 | 60 | 10 | Absence | 30 or less | Absence |
| 12 | 0.030 | 1.5 | 0.4 | 200 | 10 | 11 | Absence | 30 to 50 | Absence |

TABLE 2

| | Configuration of lead alloy sheet | | | | | | | | |
|---|---|---|---|---|---|---|---|---|---|
| | Content | Content | | | | | | | |
| | ratio of | ratio of | | | | | Test results | | |
| | Ca in | Sn in | | Heat treatment | | | | | Bubble |
| | lead | lead | Plate | conditions | | | | Corrosive | intervention |
| | alloy | alloy | thickness | Temperature | Time | Vickers | Through- | amount | at the time of |
| No. | (mass %) | (mass %) | (mm) | (° C.) | (min) | hardness | hole | (mg/cm²) | attaching |
| 4 | 0.010 | 1.5 | 0.4 | 200 | 60 | 8 | Absence | 30 or less | Absence |
| 5 | 0.010 | 1.5 | 0.4 | 250 | 1 | 11 | Absence | More than 50 | Absence |
| 6 | 0.010 | 1.5 | 0.4 | 60 | 5 | 13 | Absence | More than 50 | Presence |

TABLE 3

| | Configuration of lead alloy sheet | | | | | | | | |
|---|---|---|---|---|---|---|---|---|---|
| | Content | Content | | | | | | | |
| | ratio of | ratio of | | | | | Test results | | |
| | Ca in | Sn in | | Heat treatment | | | | | Bubble |
| | lead | lead | Plate | conditions | | | | Corrosive | intervention at |
| | alloy | alloy | thickness | Temperature | Time | Vickers | Through- | amount | the time of |
| No. | (mass %) | (mass %) | (mm) | (° C.) | (min) | hardness | hole | (mg/cm²) | attaching |
| 10 | 0.010 | 0.5 | 0.4 | 310 | 3 | 8 | Absence | 30 to 50 | Absence |
| 8 | 0.010 | 1.0 | 0.4 | 200 | 45 | 8 | Absence | 30 or less | Absence |
| 4 | 0.010 | 1.5 | 0.4 | 200 | 60 | 8 | Absence | 30 or less | Absence |
| 14 | 0.010 | 1.9 | 0.4 | 220 | 30 | 8 | Absence | 30 or less | Absence |
| 9 | 0.010 | 2.0 | 0.4 | 250 | 10 | 8 | Presence | 30 or less | Absence |

TABLE 4

| | Configuration of lead alloy sheet | | | | | | | | |
|---|---|---|---|---|---|---|---|---|---|
| | Content | Content | | | | | | | |
| | ratio of | ratio of | | | | | Test results | | |
| | Ca in | Sn in | | Heat treatment | | | | | Bubble |
| | lead | lead | Plate | conditions | | | | Corrosive | intervention at |
| | alloy | alloy | thickness | Temperature | Time | Vickers | Through- | amount | the time of |
| No. | (mass %) | (mass %) | (mm) | (° C.) | (min) | hardness | hole | (mg/cm²) | attaching |
| 13 | 0.010 | 1.5 | 0.1 | 120 | 900 | 7 | Absence | 30 or less | Absence |
| 3 | 0.010 | 1.5 | 0.3 | 150 | 600 | 7 | Absence | 30 or less | Absence |
| 4 | 0.010 | 1.5 | 0.4 | 200 | 60 | 8 | Absence | 30 or less | Absence |
| 7 | 0.010 | 1.5 | 0.5 | 310 | 5 | 8 | Absence | 30 or less | Presence |

From the results in Tables 1 to 4, when the lead alloy sheet has a thickness of 0.1 mm or more and 0.4 mm or less (e.g., less than 0.5 mm), is formed of a lead alloy in which a content ratio of tin (Sn) is 1.0 mass % or more and 1.9 mass % or less (e.g., less than 2.0 mass %), a content ratio of calcium (Ca) is 0.005 mass % or more and 0.028 mass % or less (e.g., less than 0.030 mass %), and a balance is lead (Pb) and unavoidable impurities, and has a Vickers hardness of 10 or less when measured by a micro Vickers hardness test specified in JIS Z2244:2009, it can be seen that, in a case where the lead alloy sheet is attached to the surface of the substrate formed of an ABS resin, air bubbles do not intervene. Corrosion resistance is excellent.

Table 1 is a table summarizing the results for samples having a thickness of 0.4 mm, the same content ratio of tin (Sn) of 1.5 mass %, and different content ratios of calcium (Ca). Note that the Vickers hardness of each of the samples summarized in Table 1 is 11 or less. From the table, it can be seen that while the alloy sheet No. 1 not containing calcium (Ca) and the alloy sheet No. 12 having a content ratio of calcium (Ca) of 0.030 mass % had a corrosive amount of 30 to 50 mg/cm², the alloy sheets Nos. 2, 4, 11, and 15 having a content ratio of calcium (Ca) of 0.005 mass % or more and 0.028 mass % or less had a corrosive amount of 30 mg/cm² or less, and when the content ratio of calcium (Ca) was 0.005 mass % or more and 0.028 mass % or less, excellent corrosion resistance was obtained.

Table 2 is a table summarizing the results for samples having a thickness of 0.4 mm, the same content ratio of tin (Sn) of 1.5 mass %, the same content ratio of calcium (Ca) of 0.010 mass %, and different Vickers hardness. As can be seen from the table, the alloy sheet No. 4 having a Vickers hardness of 8 had excellent corrosion resistance at a corrosive amount of 30 mg/cm² or less and had no bubble intervention at the time of attaching, whereas the alloy sheets Nos. 5 and 6 having a Vickers hardness of more than 10 had a corrosive amount of more than 50 mg/cm², which was problematic in terms of corrosion resistance. In addition, in the alloy sheet No. 6 having a Vickers hardness of 13, bubble intervention also occurred at the time of attaching.

Table 3 is a table summarizing the results for samples having a thickness of 0.4 mm, the same content ratio of calcium (Ca) of 0.010 mass %, the same Vickers hardness of 8, and different content ratios of tin (Sn). From the table, it can be seen that while the alloy sheet No. 10 having a content ratio of tin (Sn) of 0.5 mass % had a corrosive amount of 30 to 50 mg/cm², the alloy sheets Nos. 8, 4, 14, and 9 having a content ratio of tin (Sn) of 1.0 mass % to 2.0 mass % had a corrosive amount of 30 mg/cm² or less, and when the content ratio of tin (Sn) was 1.0 mass % or more, excellent corrosion resistance was obtained. However, in the alloy sheet No. 9 in which the content ratio of tin (Sn) was 2.0 mass %, through-holes were formed.

Table 4 is a table summarizing the results for samples having the same content ratio of calcium (Ca) of 0.010 mass %, the same content ratio of tin (Sn) of 1.5 mass %, a Vickers hardness of 7 or 8, and different thicknesses. From the table, it can be seen that bubble intervention occurred at the time of attaching in the thick alloy sheet having a thickness of 0.5 mm.

The following is a list of reference signs used in this specification and in the drawings.
100 Bipolar lead-acid storage battery
110 Cell member
111 Positive electrode
112 Negative electrode
11a Positive electrode lead foil (positive electrode current collector plate)
112a Negative electrode lead foil (negative electrode current collector plate)
111b Positive active material layer
112b Negative active material layer
111c Through-hole
111d Through-hole
112c Through-hole
112d Through-hole
113 Separator
113a Through-hole
120 Biplate
121 Substrate of biplate
121a Through-hole of substrate
121b First recess of substrate
121c Second recess of substrate
122 Frame body of biplate
123 Column portion
130 First end plate
131 Substrate of first end plate
131b Recess
132 Frame body of first end plate
133 Column portion
140 Second end plate
141 Substrate of second end plate
141b Recess
142 Frame body of second end plate
143 Column portion
150 Adhesive layer
160 Electrical conductor
C Cell (space housing cell member)

What is claimed is:

1. A current collector sheet for a lead-acid storage battery, wherein the current collector sheet:
is formed of a lead alloy in which a content ratio of tin (Sn) is 1.0 mass % or more and less than 2.0 mass %, a content ratio of calcium (Ca) is 0.005 mass % or more and less than 0.030 mass %, and a balance is lead (Pb) and unavoidable impurities;
has a Vickers hardness of 10 or less when measured by a micro Vickers hardness test specified in JIS Z2244:2009; and
has a thickness of less than 0.5 mm.

2. A lead-acid storage battery comprising the current collector sheet for a lead-acid storage battery according to claim 1.

3. A bipolar lead-acid storage battery, comprising:
a plurality of cell members, each including a positive electrode including a positive electrode current collector plate and a positive active material layer, a negative electrode including a negative electrode current collector plate and a negative active material layer, and a separator interposed between the positive electrode and the negative electrode, wherein the plurality of cell members are arranged in a stack manner with intervals; and
a plurality of space forming members each forming a plurality of spaces for individually housing the plurality of cell members, wherein:
the space forming member includes a resin substrate that covers at least one of a side of the positive electrode and a side of the negative electrode of the cell member, and a frame body that surrounds a side surface of the cell member;
the cell member and the substrate of the space forming member are arranged to be alternately stacked;
the plurality of cell members are electrically connected in series, and the frame bodies adjacent to each other are joined to each other;
the positive electrode current collector plate is the current collector sheet for a lead-acid storage battery according to claim 1; and
the positive electrode current collector plate is attached to a surface of the substrate.
